(19) United States
(12) Patent Application Publication
(10) Pub. No.: US 2012/0247522 A1
(43) Pub. Date: Oct. 4, 2012

(54) DECARBONIZATION DEVICE

(75) Inventor: Wen-Chang LIN, Kaohsiung City (TW)

(73) Assignee: EPOCH ENERGY TECHNOLOGY CORP., Kaohsiung City (TW)

(21) Appl. No.: 13/305,264

(22) Filed: Nov. 28, 2011

(30) Foreign Application Priority Data
Apr. 1, 2011 (TW) 100205910

(51) Int. Cl. B08B 5/00; B08B 7/04; B08B 9/00

(52) U.S. Cl. 134/56 R; 134/57 R

(57) ABSTRACT

A decarbonization device for engine decarbonization includes an oxyhydrogen supplying unit, an oxyhydrogen conduit unit connected to the oxyhydrogen supplying unit, a sensor unit disposed at the oxyhydrogen conduit unit for detecting inner gas pressure within the oxyhydrogen conduit unit, and a control unit coupled to the sensor unit and the oxyhydrogen supplying unit. The oxyhydrogen conduit unit is configured to be connected to an engine to be supplied with oxyhydrogen gas from the oxyhydrogen supplying unit. The sensor unit generates a notifying signal upon detecting the inner gas pressure greater than a predetermined value, and the control unit controls supply of the oxyhydrogen gas upon receipt of the notifying signal from the sensor unit.

### BACKGROUND OF THE INVENTION

1. Field of the Invention

The present invention relates to a decarbonization device for engine decarbonization, more particularly to a decarbonization device for engine decarbonization that is capable of detecting abnormal operation of an engine during decarbonization.

2. Description of the Related Art

Generally, carbon deposits may accumulate in an engine due to poor fuel quality, irregular engine operation, polluted air, etc. When the carbon deposit in the engine accumulates to a certain amount, several problems of the engine, such as unstable fuel supply, efficiency reduction, knocking detonation, vibration, difficulty in starting the engine, flameout, increase of fuel consumption, etc., will occur.

Taiwanese Utility Model No. M353996 discloses a conventional decarbonization device configured to be connected to an engine 14 for engine decarbonization. As shown in FIG. 1, the conventional decarbonization device includes an oxyhydrogen generating unit 11 configured to generate oxyhydrogen gas, a water vapor generating unit 12 configured to generate water vapor, and a conduit unit 13 fluidly connecting the oxyhydrogen generating unit 11 and the water vapor generating unit 12 to the engine 14. The oxyhydrogen generating unit 11 includes a plurality of electrode plates 112, and an electric power supply 113 providing electric power to the electrode plates 112 so as to electrolytically convert an electrolyte 110 into the oxyhydrogen gas. When the engine 14 operates in a normal state, the engine 14 has a negative pressure therein, and accordingly, the oxyhydrogen gas from the oxyhydrogen generating unit 11 and the water vapor from the water vapor generating unit 12 can be provided to the engine 14 through the conduit unit 13 for softening carbon deposits in the engine 14. Thus, engine decarbonization for the engine 14 can be implemented effectively.

However, when the engine 14 operates in an abnormal state or suddenly experiences flameout, the engine 14 will fail to generate a negative pressure therein so that the fuel will be ignited over early and this will affect the operation of the conventional decarbonization device.

### SUMMARY OF THE INVENTION

Therefore, an object of the present invention is to provide a decarbonization device for engine decarbonization that is capable of detecting abnormal operation of an engine during decarbonization.

Accordingly, a decarbonization device of the present invention is configured to be connected to an engine for engine decarbonization. The decarbonization device comprises an oxyhydrogen supplying unit for supplying oxyhydrogen gas, an oxyhydrogen conduit unit connected to the oxyhydrogen supplying unit, a sensor unit disposed at the oxyhydrogen conduit unit for detecting inner gas pressure within the oxyhydrogen conduit unit, and a control unit coupled to the sensor unit and the oxyhydrogen supplying unit.

The oxyhydrogen conduit unit is configured to be connected to the engine for providing the oxyhydrogen gas from the oxyhydrogen supplying unit to the engine. The sensor unit is operable to generate a notifying signal upon detecting the inner gas pressure that is greater than a predetermined value, and the control unit is operable to control supply of the oxyhydrogen gas from the oxyhydrogen supplying unit to the engine upon receipt of the notifying signal from the sensor unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional decarbonization device disclosed in Taiwanese Utility Model No. M353996;

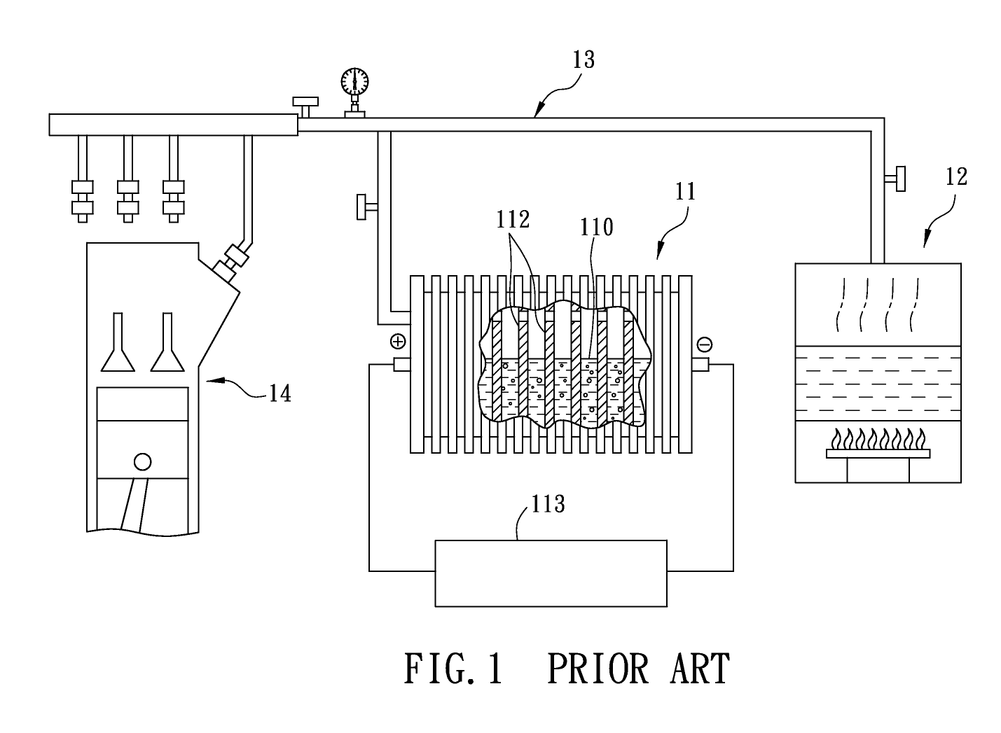

FIG. 2 is a schematic diagram of a first preferred embodiment of a decarbonization device of the present invention;

FIG. 3 is a schematic diagram illustrating a panel of the decarbonization device of the first preferred embodiment;

FIG. 4 is a block diagram illustrating electrical connections among components of the decarbonization device of the first preferred embodiment;

FIG. 5 is a schematic diagram of a second preferred embodiment of a decarbonization device of the present invention; and

FIG. 6 is a block diagram illustrating electrical connections among components of the decarbonization device of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

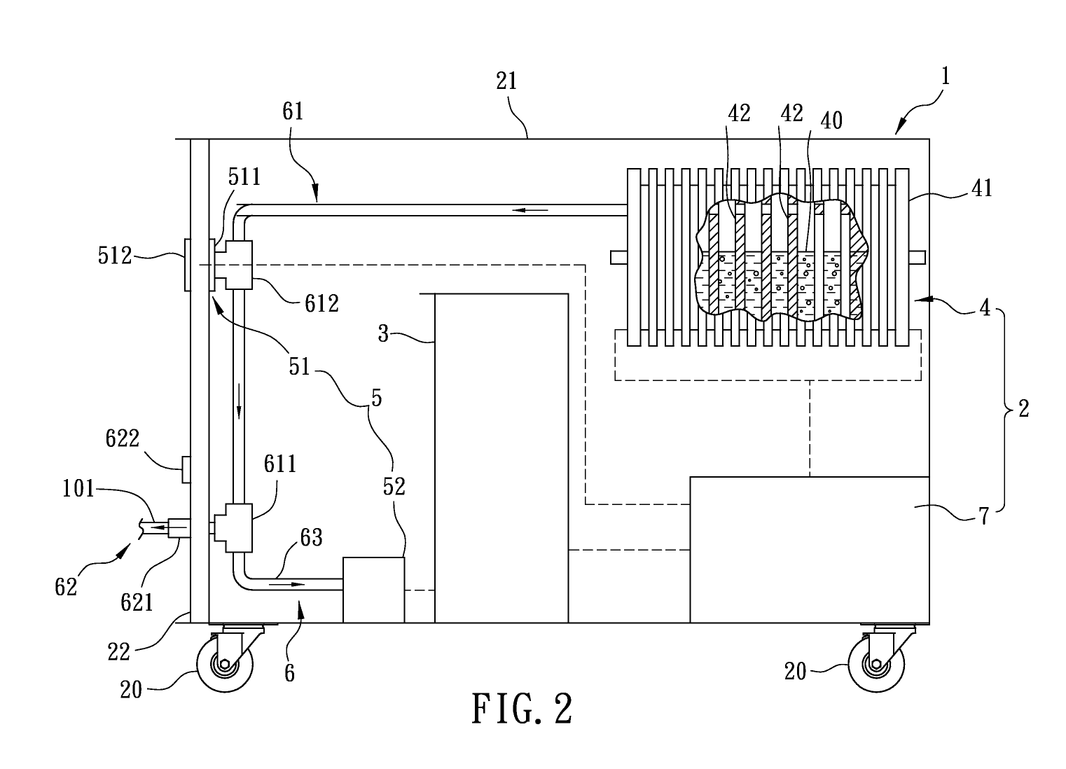

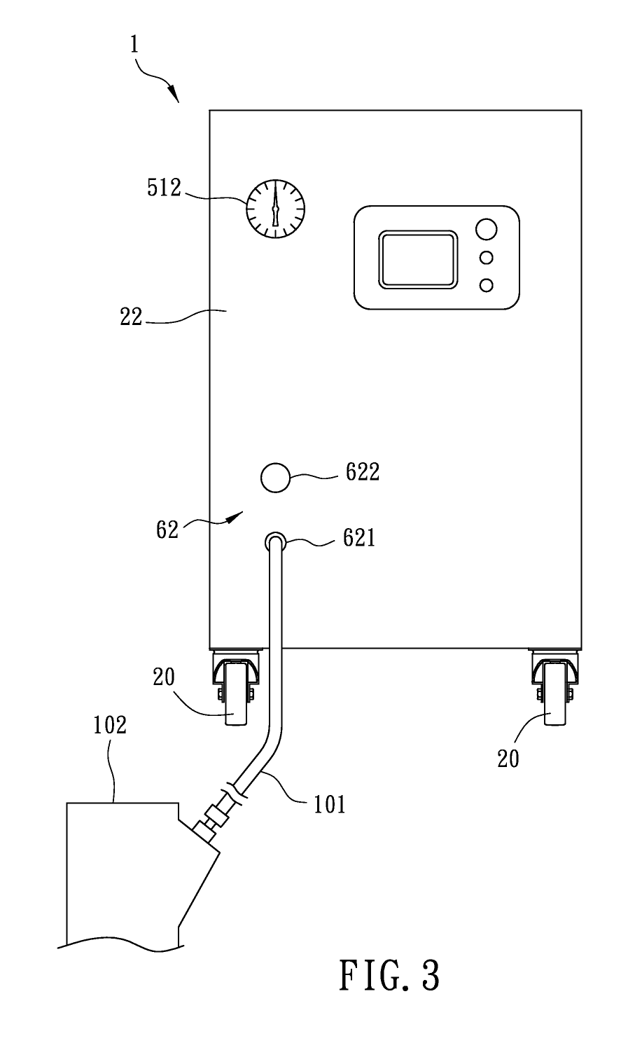

Referring to FIGS. 2 to 4, the first preferred embodiment of a decarbonization device 1 according to this invention is configured to be connected to an engine 102 through an outlet pipe 101 so that oxyhydrogen gas can be provided from the decarbonization device 1 to the engine 102 for engine decarbonization. The decarbonization device 1 includes a housing 21, a panel 22 mounted to the housing 21, an oxyhydrogen supplying unit 2, a control unit 3, a sensor unit 5, and an oxyhydrogen conduit unit 6. The housing 21 accommodates the control unit 3, the oxyhydrogen supplying unit 2, and the sensor unit 5 therein. In addition, the decarbonization device 1 further includes a plurality of wheels 20 disposed at a bottom side of the housing 21 to facilitate movement of the decarbonization device 1 from one place to another.

The oxyhydrogen supplying unit 2 is configured for supplying the oxyhydrogen gas for engine decarbonization, and includes an oxyhydrogen generating module 4 for electrolytically converting an electrolyte 40 into the oxyhydrogen gas and an electric power supply 7 electrically connected to the oxyhydrogen generating module 4 for providing electric power thereto. The oxyhydrogen generating module 4 includes an electrolyte container 41 for receiving the electrolyte 40, and a plurality of electrode plates 42 disposed in the electrolyte container 41 in spaced apart relation to one another.

The oxyhydrogen conduit unit 6 is connected to the oxyhydrogen generating module 4 of the oxyhydrogen supplying unit 2, and is configured to be connected to the engine 102 through the outlet pipe 101 for providing the oxyhydrogen gas from the oxyhydrogen generating module 4 to the engine 102. The oxyhydrogen conduit unit 6 includes an outlet mechanism 62 configured to be connected to the engine 102 through the outlet pipe 101, a first passage 61 connected between the electrolyte container 41 of the oxyhydrogen generating module 4 and the outlet mechanism 62, and a second passage 63 connected between the first passage 61 and the sensor unit 5. The outlet mechanism 62 includes an exhaust valve 621 configured to be connected to the outlet pipe 101, and an adjuster 622 disposed on the panel 22 and operable to control a flow amount of the oxyhydrogen gas through the exhaust valve 621 to the outlet pipe 101. In particular, a first three-way connector 611 is connected among the exhaust valve 621 of the outlet mechanism 62, one end of the first passage 61, and one end of the second passage 63.

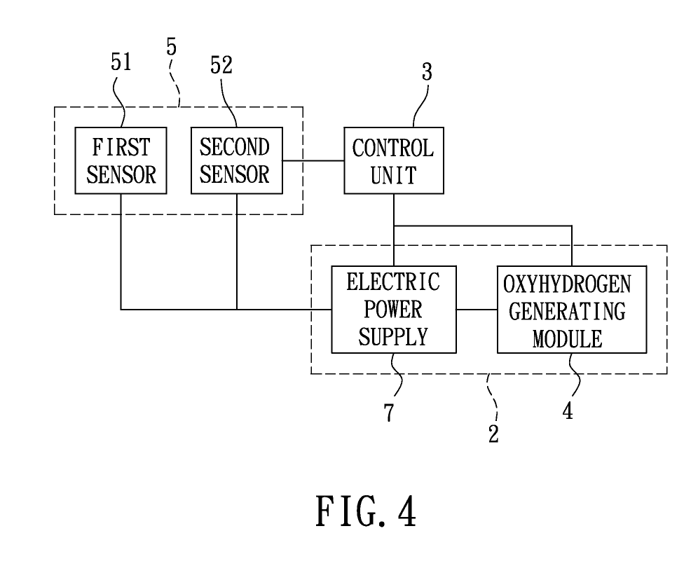

The sensor unit 5 is operable to detect inner gas pressure within the oxyhydrogen conduit unit 6, and includes a first sensor 51 and a second sensor 52. The first sensor 51 is disposed on the panel 22 and includes a gas pressure detecting element 511 connected to the first passage 61 by a second three-way connector 612 for detecting the inner gas pressure within the first passage 61, and a pressure meter 512 disposed on the panel 22 and coupled to the gas pressure detecting element 511 for indicating the inner gas pressure detected thereby. In particular, the second sensor 52 is coupled to the control unit 3, and the second passage 63 of the oxyhydrogen conduit unit 6 is connected between the first three-way connector 611 and the second sensor 52 of the sensor unit 5. The second sensor 52 is operable, upon detecting the inner gas pressure within the second passage 63 that is greater than a predetermined value, to generate and send a notifying signal to the control unit 3. As shown in FIG. 4, the electric power supply 7 is further electrically connected to the first and second sensors 51, 52 of the sensor unit 5 for providing electric power thereto.

The control unit 3 is coupled to second sensor 52 of the sensor unit 5, and the oxyhydrogen generating module 4 and the electric power supply 7 of the oxyhydrogen supplying unit 2, and is operable to control supply of the oxyhydrogen gas from the oxyhydrogen generating module 4 to the engine 102 upon receipt of the notifying signal from the second sensor 52 of the sensor unit 5. In particular, the control unit 3 is operable to control the electric power supply 7 to stop providing the electric power to the electrode plates 42 of the oxyhydrogen generating module 4 upon receipt of the notifying signal. Since the function of the control unit 3 can be achieved by a commercially available processor cooperating with other electronic components in a known way, details of the construction of the control unit 3 will be omitted herein for the sake of brevity.

After the engine 102 starts operating, the control unit 3 is operable to control the electric power supply 7 to provide the electric power to the electrode plates of the oxyhydrogen generating module 4 to electrolytically convert the electrolyte 40 into the oxyhydrogen gas. Then, the oxyhydrogen gas flows from the electrolyte container 41 of the oxyhydrogen generating module 4 to the engine 102 through the first passage 61, the exhaust valve 621 and the outlet pipe 101 in sequence, and to the second sensor 51 through the second passage 62. When the engine 102 operates in an abnormal state or suddenly experiences flameout, the engine 102 will fail to generate a negative pressure therein so that the oxyhydrogen gas cannot be exhausted from the exhaust valve 621 to the engine 102 and will accumulate in the first and second passages 61, 62. At this time, the oxyhydrogen generating module 4 continues to generate and output the oxyhydrogen gas into the first and second passages 61, 62 so that the inner gas pressure within the first and second passages 61, 62 is continuously increased. Upon detecting the inner gas pressure within the second passage 62 that is abnormal, the second sensor 52 is operable to generate the notifying signal to notify the control unit 3 to control the electric power supply 7 to stop providing the electric power to the oxyhydrogen generating module 4. Accordingly, the oxyhydrogen generating module 4 stops generating and outputting the oxyhydrogen gas into the first and second passages 61, 62.

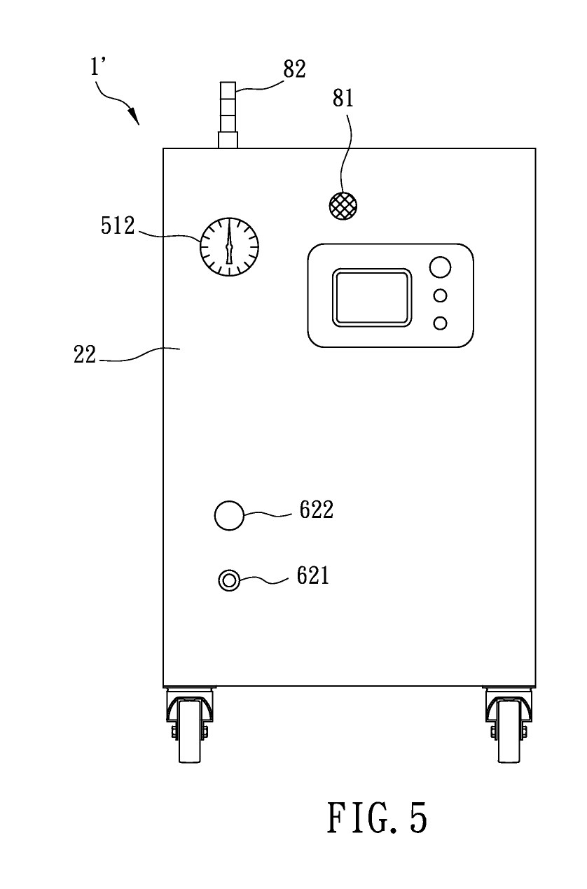

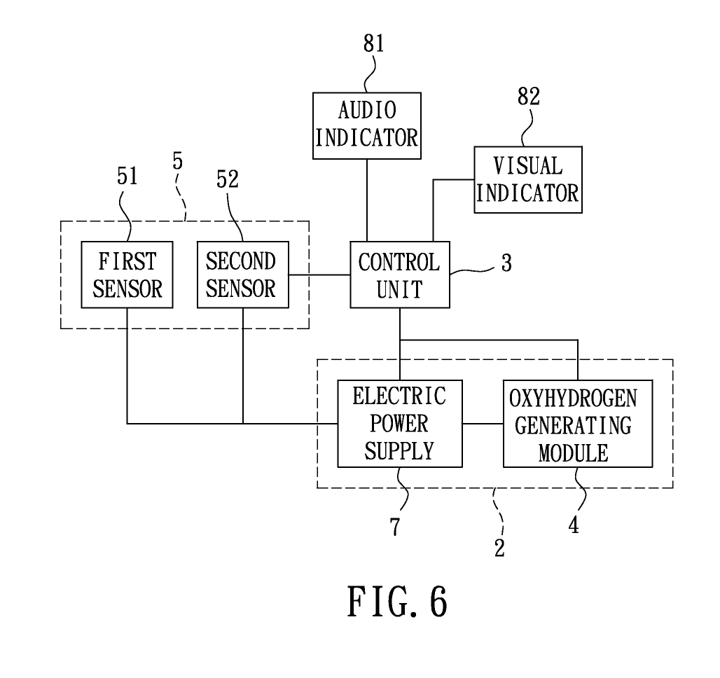

Referring FIGS. 5 and 6, the second preferred embodiment of a decarbonization device 1′ according to this invention is similar to the first preferred embodiment. In this embodiment, the decarbonization device 1′ further includes an audio indicator 81 (for example, a buzzer) and a visual indicator 82 that are coupled to the control unit 3. The visual indicator is configured to generate a visual signal for indicating an operating state of the decarbonization device 1′. For example, the visual indicator 82 is configured to generate green light when the decarbonization device 1′ operates normally for engine decarbonization, yellow light when the engine decarbonization is completed, and red light when the decarbonization device 1′ operates in an abnormal state or has a fault. The control unit 3 is further operable, upon receipt of the notifying signal from the second sensor 52, to control the audio indicator 81 to generate an audible signal and to control the visual indicator 82 to generate the red light for notifying an operator to repair the engine 102.

In summary, by virtue of the second sensor 52 of the sensor unit 5, the control unit 3 can control the oxyhydrogen supplying unit 2 to stop supplying the oxyhydrogen gas when the engine 102 operates in an abnormal state or experiences flameout. Thus, over early ignition of the fuel in the engine 102, which is attributed to an excess amount of the oxyhydrogen gas in the engine 102, can be avoided so that the procedure of the engine decarbonization is relatively safe. Further, by virtue of the audio indicator 81 and the visual indicator 82, the operator may be made aware of the abnormal state of the engine 102 so that repair of the engine 102 may be conducted immediately.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A decarbonization device configured to be connected to an engine for engine decarbonization, said decarbonization device comprising:
an oxyhydrogen supplying unit for supplying oxyhydrogen gas;
an oxyhydrogen conduit unit connected to said oxyhydrogen supplying unit and configured to be connected to the engine for providing the oxyhydrogen gas from said oxyhydrogen supplying unit to the engine;
a sensor unit disposed at said oxyhydrogen conduit unit for detecting inner gas pressure within said oxyhydrogen conduit unit, said sensor unit being operable to generate a notifying signal upon detecting the inner gas pressure that is greater than a predetermined value; and
a control unit coupled to said sensor unit and said oxyhydrogen supplying unit, and operable to control supply of the oxyhydrogen gas from said oxyhydrogen supplying unit to the engine upon receipt of the notifying signal from said sensor unit.

2. The decarbonization device as claimed in claim 1, wherein said oxyhydrogen supplying unit includes an oxyhydrogen generating module for electrolytically converting an electrolyte into the oxyhydrogen gas, and an electric power supply electrically connected to said oxyhydrogen generating module for providing electric power thereto.

3. The decarbonization device as claimed in claim 2, wherein said control unit is coupled to said electric power supply of said oxyhydrogen supplying unit, and is operable to control said electric power supply to stop providing the electric power to said oxyhydrogen generating module upon receipt of the notifying signal.

4. The decarbonization device as claimed in claim 2, wherein said oxyhydrogen generating module of said oxyhydrogen supplying unit includes an electrolyte container for receiving the electrolyte, and a plurality of electrode plates disposed in said electrolyte container in spaced apart relation to one another, said control unit being operable to control provision of the electric power from said electric power supply to said electrode plates.

5. The decarbonization device as claimed in claim 1, wherein said oxyhydrogen conduit unit includes an outlet mechanism configured to be connected to the engine, a first passage connected between said oxyhydrogen supplying unit and said outlet mechanism, and a second passage connected between said first passage and said sensor unit.

6. The decarbonization device as claimed in claim 5, wherein said sensor unit includes a first sensor mounted at said first passage, and a second sensor coupled to said control unit and operable to generate and send the notifying signal to said control unit, said second passage being connected between said first passage and said second sensor.

7. The decarbonization device as claimed in claim 6, further comprising a housing for accommodating said oxyhydrogen supplying unit, said control unit and said second sensor of said sensor unit, and a panel mounted to said housing, said first sensor of said sensor unit being disposed on said panel.

8. The decarbonization device as claimed in claim 7, wherein said first sensor of said sensor unit includes a gas pressure detecting element connected to said first passage for detecting the inner gas pressure within said first passage, and a pressure meter disposed on said panel and coupled to said gas pressure detecting element for indicating the inner gas pressure detected thereby.

9. The decarbonization device as claimed in claim 5, wherein said outlet mechanism of said oxyhydrogen conduit unit includes an exhaust valve configured to be connected to the engine, and an adjuster operable to control a flow amount of the oxyhydrogen gas through said exhaust valve to the engine.

10. The decarbonization device as claimed in claim 1, further comprising an audio indicator coupled to said control unit and controlled thereby to generate an audible signal when said control unit receives the notifying signal from said sensor unit.

11. The decarbonization device as claimed in claim 10, wherein said audio indicator is a buzzer.

12. The decarbonization device as claimed in claim 1, further comprising a visual indicator coupled to said control unit and controlled thereby to generate a visual signal for indicating an operation state of said decarbonization device.
